(19) United States
(12) Patent Application Publication
(10) Pub. No.: US 2017/0034459 A1
(43) Pub. Date: Feb. 2, 2017

(54) Electronic Device with Image Correction System and Methods Therefor

(71) Applicant: Motorola Mobility LLC, Chicago, IL (US)

(72) Inventors: Peter A. Matsimanis, Glenview, IL (US); Michael Gunn, Barrington, IL (US); Valeriy Marchevsky, Glenview, IL (US)

(21) Appl. No.: 14/813,988

(22) Filed: Jul. 30, 2015

(51) Int. Cl. H04N 5/357; H04N 5/232

(52) U.S. Cl. CPC H04N 5/357; H04N 5/23222

(57) ABSTRACT

An electronic device includes an image capture device, such as a camera, a user interface and one or more processors. The one or more processors can receive an image from the image capture device and detect distortion occurring in the image. The one or more processors can then obtain weather data of a location where the image was captured and determine whether the weather data indicates a weather condition, such as fog, responsible for the distortion. Where this is the case, the one or more processors can perform distortion reduction on the image to reduce weather-related distortion occurring in the image. Otherwise, the one or more processors can present a prompt with a notification to clean at least a portion of the image capture device.

### BACKGROUND

Technical Field

This disclosure relates generally to electronic devices, and more particularly to electronic devices having image capture devices.

Background Art

Electronic communication devices, such as mobile telephones, smart phones, portable computers, gaming devices, and the like, are used by billions of people. The owners of such devices come from all walks of life. These owners use mobile communication devices for many different purposes including, but not limited to, voice communications and data communications for text messaging, Internet browsing, commerce such as banking, and social networking. The circumstances under which users of mobile communication device use their devices varies widely as well.

Many electronic communication devices include image capture devices. For example, most every smartphone or tablet computer sold today comes with at least one digital camera. Similarly, many digital cameras now come with electronic communication devices so that images can be transferred to computers or other electronic devices. One challenge with this plethora of image capture devices is keeping the lenses and other components clean. Where a person places a smartphone in their pocket, for example, when a call is received they may grab the device by placing a finger atop the lens of the camera. They may not even be aware that this has occurred, but may subsequently be disappointed when a captured image is blurry due to fingerprint smudges along the lens. It would be advantageous to have an improved electronic device that can reduce the occurrence of distorted images.

### BRIEF DESCRIPTION OF THE DRAWINGS

FIG. 1 illustrates one explanatory portable electronic device in accordance with one or more embodiments of the disclosure.

FIG. 2 illustrates the explanatory electronic device along with a block diagram schematic of some explanatory sensors that can be incorporated into the electronic device in accordance with one or more embodiments of the disclosure.

FIG. 3 illustrates the explanatory device in communication with various remote devices in accordance with one or more embodiment of the disclosure.

FIG. 4 illustrates one explanatory capturing an image with an image capture device in accordance with one or more embodiments of the disclosure.

FIG. 5 illustrates an explanatory method in accordance with one or more embodiments of the disclosure.

FIG. 6 illustrates one or more explanatory method step options in accordance with one or more embodiments of the disclosure.

FIG. 7 illustrates one or more explanatory method steps in accordance with one or more embodiments of the disclosure.

FIG. 8 illustrates one or more explanatory method steps in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to image correction in an electronic device. Any process descriptions or blocks in flow charts should be understood as representing modules, segments, or portions of code that include one or more executable instructions for implementing specific logical functions or steps in the process.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more device-specific processors and unique stored program instructions that control the one or more processors to implement, in conjunction with certain non-processor circuits, some, most, or all of the functions of correcting images and/or providing user prompts as described herein. The non-processor circuits may include, but are not limited to, a radio receiver, a radio transmitter, signal drivers, clock circuits, power source circuits, and user input devices. As such, these functions may be interpreted as steps of a method to either correct images or provide an indication to a user that a portion of an image capture device, like a lens, may need to be cleaned. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that the advent of incorporating digital image capture devices into electronic devices with communication capabilities has given rise to the constant need for users to inspect, and clean, the image capture devices in their electronic devices. Users must, for example, clean off fingerprints, smudges, finger residues, foodstuffs, foreign materials, or other debris from the lens of their image capture device. Moreover, as noted above, many users may not be cognizant that the lens or other externally exposed portion of the image capture device needs cleaning. This is especially true at night when debris, fingerprints, or other materials are difficult to see. When the lens is not clean, any images captured by the image capture device can be compromised by distortion. One of the more common distortion characteristics results in the image looking foggy or hazy.

At the same time, embodiments of the disclosure contemplate that people do capture images that are not always in true focus. For example, if an image capture device has a lens with a large aperture, the lens will have a short depth of focus. This results in some portions of an image being in sharp focus while other portions are not in focus. Similarly, some people take images in poor weather conditions. Rain, fog, mist, high humidity, and other conditions may result in an image that looks foggy or hazy as well.

Embodiments of the disclosure provide an electronic device, corresponding systems, and corresponding methods for either notifying a user that their image capture device may need cleaning, or alternatively applying a defogging image correction process to an image to present a clearer and more in-focus image as an option to the user. In one embodiment, embodiments of the disclosure apply methods of fog or inclement weather detection, along with location, to determine whether received or obtained weather data of a location where an image was captured indicates one or more weather conditions causing distortion in an image. Where it does, embodiments of the disclosure can perform distortion reduction, such as by applying a defogging algorithm to the image, to reduce weather-related distortion occurring in an image. However, where the weather data indicates that the distortion is caused by conditions other than the weather, in one embodiment a prompt can be presented to the user. The prompt can include a notification to clean at least a portion, e.g., the lens, of an image capture device so that less distorted pictures can be captured.

In one or more embodiments, one or more processors can apply defogging image correction and haze detection and other distortion recognition processes, along with current or previous weather conditions of the location where an image is captured. If the weather conditions at the location indicate that inclement weather, such as fog or haze, was occurring when the image was taken, the one or more processors can then apply a defogging algorithm to reduce distortion in an image. In one embodiment, the lesser-distorted image can be presented to the user as an option so that the user can determine which image they prefer. This preferred image can then be stored in memory. In some embodiments, the lesser-distorted image can be stored in memory automatically, either in addition to, or instead of, the original image.

On the other hand, if the weather conditions were not indicating inclement weather at the location, when distortion such as blur or an out-of-focus condition is detected the one or more processors can present a prompt on a user interface instructing the user to inspect at least a portion of the image capture device, such as the lens, for potential contaminants, such as smudges, fingerprints, residues, or foreign material. This alerts the user to the fact that the lens or other portion of the image capture device may not be clean and may be causing compromised images.

In one embodiment, the weather data can be pulled from a weather service capable of delivering weather data as a function of location, namely, the location where the image was taken. However, embodiments of the disclosure contemplate that in some situations no such weather data will be available. To accommodate such situations, in one or more embodiments the one or more processors can execute a real time search of social media servers. For example, the one or more processors may search social media images at servers of services such as Instagram™, Facebook™, Twitter™, SnapChat™, or other social media services for other people's images that may have been taken at about the same location and at about the same time. The one or more processors can then examine then apply image distortion detection to these images to determine whether they exhibit the same distortion as those captured by the local image capture device. Where they do, the one or more processors can apply the defogging or other image correction processes to reduce weather-related distortion. Where they do not, the one or more processors can optionally present a prompt on the user interface instructing the user to inspect the exterior components of the image capture device.

In one embodiment, a method in an electronic device includes detecting, by one or more processors, distortion in an image captured by an imager of the electronic device. The distortion can be detected in one of a variety of ways, one of which is by applying a haze, blur, or out-of-focus detection process to the image.

In one embodiment, the one or more processors then obtain weather data of a location where the image was captured. As noted above, the weather data can come from a variety of sources. In one embodiment, the weather data is retrieved by a communication device from a weather service server across a network. In another embodiment, the weather data is retrieved by the communication device from a social media server across a network. Other techniques can be used as well. For example, in another embodiment, the electronic device can be equipped with various environmental sensors, such as a barometer, thermometer, infrared sensors, hygrometer, galvanic monitor, or moisture detector. Where this is the case, the one or more processors may simply obtain the weather data from these sensors directly when the image is captured. While retrieving the weather data from a remote server requires knowledge of location, retrieving weather data directly from local environmental sensors eliminates the need to precisely determine location.

In one embodiment, once the weather data is obtained, the one or more processors can determine whether the weather data indicates one or more weather conditions causing the distortion. Where this is the case, i.e., where the one or more weather conditions appear to be causing the distortion, the one or more processors can perform distortion reduction on the image to reduce weather-related distortion occurring in the image. However, where the one or more weather conditions appear not to be causing the distortion, the one or more processors can optionally present a prompt on a user interface of the electronic device. In one embodiment, the prompt includes a notification to clean at least a portion of the image capture device.

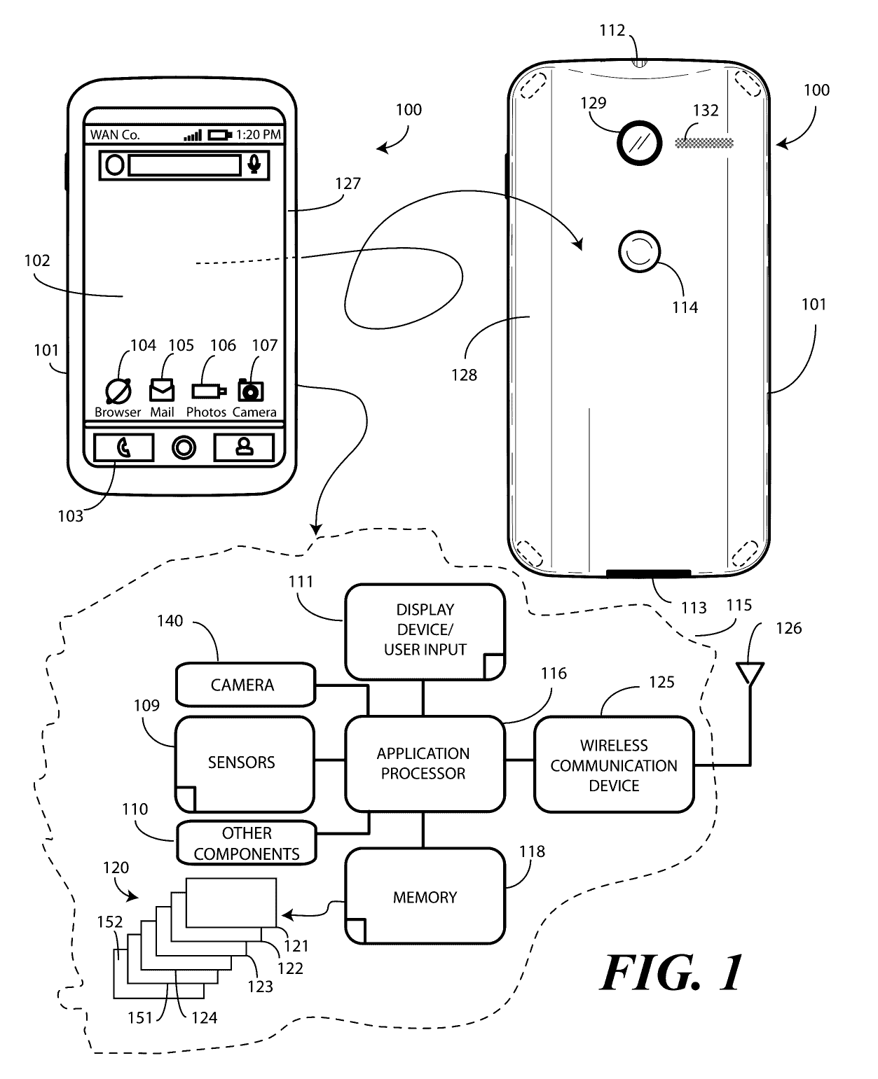

Turning now to FIG. 1, illustrated therein is one explanatory electronic device 100 configured in accordance with one or more embodiments of the disclosure. The electronic device 100 of FIG. 1 is a portable electronic device, and is shown as a smart phone for illustrative purposes. However, it should be obvious to those of ordinary skill in the art having the benefit of this disclosure that other electronic devices may be substituted for the explanatory smart phone of FIG. 1. For example, the electronic device 100 could equally be a conventional desktop computer, a digital camera, such as a digital-Single Lens Reflex (SLR) or simple digital camera, camera palm-top computer, a tablet computer, a gaming device, a media player, or other device.

This illustrative electronic device 100 includes a display 102, which may optionally be touch-sensitive. In one embodiment where the display 102 is touch-sensitive, the display 102 can serve as a primary user interface 111 of the electronic device 100. Users can deliver user input to the display 102 of such an embodiment by delivering touch input from a finger, stylus, or other objects disposed proximately with the display. In one embodiment, the display 102 is configured as an active matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 1 includes a housing 101. In one embodiment, the housing 101 includes two housing members. A front housing member 127 is disposed about the periphery of the display 102 in one embodiment. A rear-housing member 128 forms the backside of the electronic device 100 in this illustrative embodiment and defines a rear major face of the electronic device. Features can be incorporated into the housing members 127,128. Examples of such features include an image capture device, which is shown in FIG. 1 as a digital camera 140 having an exterior lens 129, or an optional speaker port 132. The digital camera 140 is shown as being disposed on the rear major face of the electronic device 100 in this embodiment. However, embodiments of the disclosure are not so limited. For example, the digital camera 140 could be disposed along the front major face of the electronic device 100 as well. Similarly, multiple cameras could be disposed along the electronic device 100. In this illustrative embodiment, a user interface component 114, which may be a button or touch sensitive surface, can also be disposed along the rear-housing member 128.

In one embodiment, the electronic device 100 includes one or more connectors 112,113, which can include an analog connector, a digital connector, or combinations thereof. In this illustrative embodiment, connector 112 is an analog connector disposed on a first edge, i.e., the top edge, of the electronic device 100, while connector 113 is a digital connector disposed on a second edge opposite the first edge, which is the bottom edge in this embodiment.

A block diagram schematic 115 of the electronic device 100 is also shown in FIG. 1. In one embodiment, the electronic device 100 includes one or more processors 116. In one embodiment, the one or more processors 116 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 118, can optionally store the executable software code used by the one or more processors 116 during operation.

In this illustrative embodiment, the electronic device 100 also includes a communication circuit 125 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The communication circuit 125 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology. The communication circuit 125 can include wireless communication circuitry, one of a receiver, a transmitter, or transceiver, and one or more antennas 126.

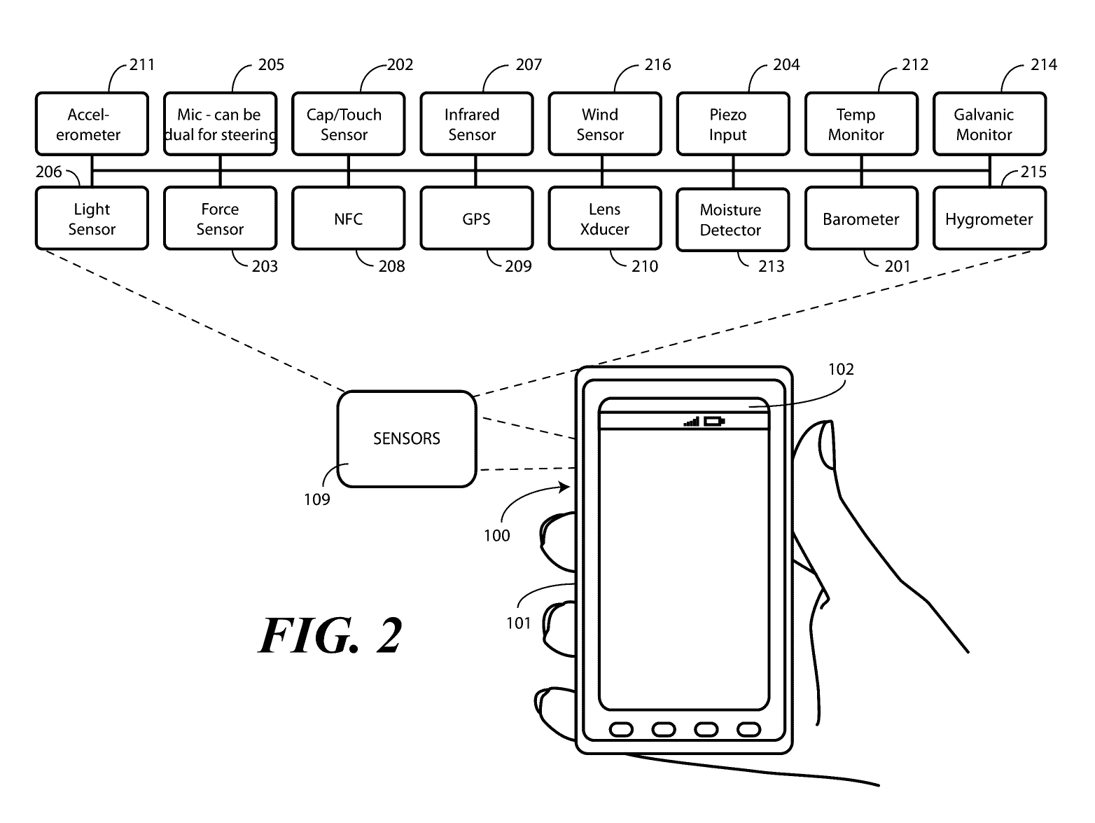

The communication circuit 125 can be configured to retrieve weather data from one or more servers across a network. In one or more embodiments, the communication circuit 125 retrieves weather data from servers as a function of the location of the electronic device when a particular image is captured. The location can be determined using one or more other sensors 109, as will be described in more detail below with reference to FIG. 2. In one or more embodiments, the one or more processors 116 can use the communication circuit to communicate with one or more social networking servers or applications, one or more weather service servers or applications, or combinations thereof. Additionally, weather and imaging news feeds and other data can be received through the communication circuit 125. Moreover, context and location sensitive notifications can be obtained using the communication circuit 125.

In one embodiment, the one or more processors 116 can be responsible for performing the primary functions of the electronic device 100. For example, in one embodiment the one or more processors 116 comprise one or more circuits operable with one or more user interface devices 111, which can include the display 102, to present presentation information to a user. The executable software code used by the one or more processors 116 can be configured as one or more modules 120 that are operable with the one or more processors 116. Such modules 120 can store instructions, control algorithms, and so forth.

In one embodiment, the one or more processors 116 are responsible for running the operating system environment 121. The operating system environment 121 can include a kernel 122 and one or more drivers, and an application service layer 123, and an application layer 124. The operating system environment 121 can be configured as executable code operating on one or more processors or control circuits of the electronic device 100.

The application layer 124 can be responsible for executing application service modules. The application service modules may support one or more applications or “apps.” Examples of such applications shown in FIG. 1 include a cellular telephone application 103 for making voice telephone calls, a web browsing application 104 configured to allow the user to view webpages on the display 102 of the electronic device 100, an electronic mail application 105 configured to send and receive electronic mail, a photo application 106 configured to permit the user to view images or video on the display 102 of electronic device 100, and a camera application 107 configured to capture still (and optionally video) images with the digital camera 140. These applications are illustrative only, as others will be obvious to one of ordinary skill in the art having the benefit of this disclosure. The applications of the application layer 124 can be configured as clients of the application service layer 123 to communicate with services through application program interfaces (APIs), messages, events, or other inter-process communication interfaces. Where auxiliary processors are used, they can be used to execute input/output functions, actuate user feedback devices, and so forth.

In one or more embodiments, the one or more modules 120 can include a distortion detection module 151. The one or more processors 116 can use the distortion detection module 151 to detect distortion in an image captured by an imager of the electronic device 100, such as the digital camera 140. Distortion detection can occur in numerous ways. The one or more processors 116 can use the distortion detection module 151 to detect blur in an image, haze in an image, an out-of-focus condition, combinations thereof, or other distortion.

Illustrating by example, in one embodiment the distortion detection module 151 can include assessing sharpness of lines and other delineations occurring in the image to detect blur, haze, out-of-focus conditions, or other visible distortion. Similarly, the distortion detection module 151 can determine a threshold noise level occurring in an image, or can determined an amount of jitter occurring in an image by performing a pixel shifting process to determine whether the jitter falls below a predefined jitter difference threshold to detect distortion. Other distortion techniques will be obvious to those of ordinary skill in the art having the benefit of this disclosure.

In one or more embodiments, the one or more modules 120 can also include a distortion reduction module 152. The one or more processors 116 can use the distortion reduction module 152 to perform distortion reduction on a captured image to reduce distortion occurring in the image.

As with the distortion detection module 151, the distortion reduction module 152 can take a variety of forms. For example, the one or more processors 116 may correct or otherwise compensate for distortion by performing an inverse point spread function, or deconvolution technique, to reduce distortion—weather related or otherwise—occurring in an image.

In one embodiment, the one or more processors 116 can use the distortion reduction module 152 to reduce weather-related distortion occurring in an image. For example, in one embodiment the distortion reduction module 152 includes a defogging process that can be used to remove fog from an image. In one embodiment, the defogging process includes a polarization-based method using two or more images take with different degrees of polarization to correct for fog appearing in the image. In another embodiment, the defogging process includes using a depth-based method to correct for fog or haze occurring in an image.

In another embodiment, one or more digital or actual filters can be combined as a function of local pixel information to estimate a transmission map associated with the image. Using an image-defogging model that is a function of pixel location, scene radiance and a transmission map can be determined. From this, a dark channel prior can be determined from the model to clarify the image from fog or haze.

In yet another embodiment, the defogging process can include the use of a perceptual fog density index that estimates visibility in a foggy scene by relying upon a database of reference foggy and non-foggy images. A perceptual fog density prediction model can then be used to defog and otherwise enhance the visibility of foggy or hazy scenes to reduce weather-related distortion occurring in an image. Defogging can include selective filtering of images with fog-weighted maps, and/or by the application of Laplacian multi-scale pyramidal refinement to reduce weather-related distortion occurring in an image. The techniques for reducing distortion set forth above are illustrative only, as others will be obvious to those of ordinary skill in the art having the benefit of this disclosure.

In one embodiment, the one or more processors 116 may generate commands based on the amount of distortion detected in an image with the distortion detection module 151. The one or more processors 116 may generate commands based upon information that is a function of the amount of distortion occurring in an image. For example, the one or more processors 116 may actuate or control the distortion reduction module 152, or control the parameters or techniques, such as filter selection or modeling, based upon information received from the distortion detection module 151. The one or more processors 116 may process the distortion information alone or in combination with other data, such as the information received from one or more other sensors 109 of the electronic device 100.

The one or more other sensors 109 may include a microphone, and a mechanical input component such as button or key selection sensors, touch pad sensor, touch screen sensor, capacitive sensor, and switch. Touch sensors may used to indicate whether the device is being touched at side edges, thus indicating whether or not certain orientations or movements are intentional by the user. The other sensors 109 can also include surface/housing capacitive sensors, audio sensors, imaging devices, and video sensors. The other sensors 109 can also include motion detectors, such as an accelerometer or a gyroscope. For example, an accelerometer may be embedded in the electronic circuitry of the electronic device 100 to show vertical orientation, constant tilt and/or whether the device is stationary.

Turning briefly to FIG. 2, illustrated therein are a few of the other sensors 109 that can be included with the electronic device 100. In one or more embodiments, many of these other sensors 109 are environmental sensors to detect environmental conditions about the electronic device 100. For example, in one embodiment the environmental sensors can include a barometer 201. The barometer 201 can sense changes in air pressure due to environmental and/or weather changes. In one embodiment, the barometer 201 includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

In one embodiment, the electronic device 100 can include a touch sensor 202 and/or a force sensor 203 to detect contact with a housing 101 of the electronic device 100. In one embodiment, the touch sensor 202 and/or force sensor 203 can be used to detect user input. In other embodiments, these sensors can be used to detect contact with other objects, such as metal desks or chairs. If, for example, the electronic device 100 is sitting on a table, the one or more processors (116) may conclude that the electronic device 100 is indoors. As such, any distortion occurring in an image may be due to debris or material on the lens of the camera (140) rather than due to foggy or hazy conditions.

The touch sensor 202 can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors (116), to detect an object in close proximity with—or touching—the surface of the display 102 or the housing 101 of the electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

The force sensor 203 can take various forms. For example, in one embodiment, the force sensor 203 comprises resistive switches or a force switch array configured to detect contact with either the display 102 or the housing 101 of the electronic device 100. An “array” refers to a set of at least one switch. The array of resistive switches can function as a force-sensing layer, in that when contact is made with either the surface of the display 102 or the housing 101 of the electronic device 100, changes in impedance of any of the switches may be detected. The array of switches may be any of resistance sensing switches, membrane switches, force-sensing switches such as piezoelectric switches, or other equivalent types of technology. In another embodiment, the force sensor 203 can be capacitive. In yet another embodiment, piezoelectric sensors 204 can be configured to sense force as well. For example, where coupled with the lens of the display 102, the piezoelectric sensors 204 can be configured to detect an amount of displacement of the lens to determine force. The piezoelectric sensors 204 can also be configured to determine force of contact against the housing 101 of the electronic device 100 rather than the display 102.

One or more microphones 205 can be included to receive acoustic input. While the one or more microphones 205 can be used to sense voice input, voice commands, and other audio input, in one or more embodiments they can be used as environmental sensors to sense environmental sounds such as rain, wind, and so forth. If, for example, it has recently rained when an image is captured, the one or more microphones 205 may detect this rain. The one or more processors (116) may be configured to predict steam, mist, or other atmospheric moisture within a predetermined time after a rain. Accordingly, an inference of fog or haze can be obtained from the one or more microphones 205 in one or more embodiments.

In one embodiment, the one or more microphones 205 include a single microphone. However, in other embodiments, the one or more microphones 205 can include two or more microphones. Where multiple microphones are included, they can be used for selective beam steering to, for instance, determine from which direction a sound emanated. If the electronic device 100 is in a pocket, detected sound could be coming from the garment or the atmosphere. The ability to steer the beams toward the pocket opening allows the one or more processors (116) to determine whether received noise is rainfall or chiffon crunching in one or more embodiments.

Illustrating by example, a first microphone can be located on a first side of the electronic device 100 for receiving audio input from a first direction, while a second microphone can be placed on a second side of the electronic device 100 for receiving audio input from a second direction. The one or more processors (116) can then select between the first microphone and the second microphone to beam steer audio reception toward the user. Alternatively, the one or more processors (116) can process and combine the signals from two or more microphones to perform beam steering.

In one or more embodiments, the one or more sensors 109 can include a light sensor 206. The light sensor 206 can detect changes in optical intensity, color, light, or shadow in the near vicinity of the electronic device 100. This can be used to make inferences about the weather as well. For example, if the light sensor 206 detects low-light conditions in the middle of the day when the on-board location sensors indicate that the electronic device 100 is outside, this can be due to cloudy conditions, fog, or haze. Accordingly, the one or more processors (116) can conclude that any distortion occurring in images is due to these weather conditions. In one embodiment, the light sensor 206 can be configured as an image-sensing device that captures successive images about the device and compares luminous intensity, color, or other spatial variations between images to detect weather conditions.

An infrared sensor 207 can be used in conjunction with, or in place of, the light sensor 206. The infrared sensor 207 can be configured to detect thermal emissions from objects about the electronic device 100. Where, for example, the infrared sensor 207 detects heat on a warm day, but the light sensor 206 detects low-light conditions, this can indicate fog on a summer day. Accordingly, the one or more processors (116) can conclude that any distortion occurring in images is due to these weather conditions.

A near field communication circuit 208 can be included for communication with local area networks. The one or more processors (116) can use the near field communication circuit 208 to obtain both weather data and location data of the electronic device 100. If, for example, a user is at the zoo taking pictures with the camera (140), they may be standing near an exhibit that can be identified with near field communication. This identification can indicate that the electronic device 100 is both outdoors and at the zoo. This information, along with information from the other sensors 109, can be used to infer weather conditions. Alternatively, the near field communication circuit 208 can be used to receive weather data from kiosks and other electronic devices. The near field communication circuit 208 can be used to obtain image or other data from social media networks when the weather data is not available in other embodiments. Examples of suitable near field communication circuits include Bluetooth communication circuits, IEEE 801.11 communication circuits, infrared communication circuits, magnetic field modulation circuits, and Wi-Fi circuits.

In one or more embodiments, the one or more processors (116) require location information of the electronic device 100 when a particular image is captured to ensure that the weather data received relates to a particular location. Note that the location can take many forms. In one or more embodiment, the location can be a micro-location, such as at the location of a particular home, a particular public park, or a particular city block. In other embodiments, the location can be a meso-location, such as a city, town, or county. Meso-locations are larger than micro-locations, but are smaller than macro-locations, which can be states or regions. In one or more embodiments, the location sensors of the electronic device 100 are capable of detecting, at a minimum, a meso-location. Generally, the electronic device 100 will be capable of detecting micro-location instead.

For example, in one embodiment a global positioning system device 209 can be included for determining a micro-location of the electronic device 100 when an image is captured. In one or more embodiments, the global positioning system device 209 is configured for communicating with a constellation of earth orbiting satellites or a network of terrestrial base stations to determine an approximate location. While a global positioning system device 209 is one example of a location determination device, it will be clear to those of ordinary skill in the art having the benefit of this disclosure that other location determination devices, such as electronic compasses or gyroscopes, could be used as well.

In one or more embodiments, the lens of the display 102 or of the camera 140 can be configured as a lens transducer 210 to receive audio input from the environment. Just as with the one or more microphones 205, the lens transducer 210 can be used to detect environmental conditions from weather data that indicates one or more weather conditions may be causing distortion in one or more images.

An accelerometer 211 can be included to detect motion of the electronic device 100. If, for example, the accelerometer 211 indicates that the electronic device 100 is moving when an image is captured, the one or more processors (116) may conclude that distortion in the resulting image is due to motion of the electronic device 100 rather than either weather conditions or contamination of exterior portions of the image capture device. Accordingly, the one or more processors (116) may omit presenting a prompt to the user to clean the lens, and may further omit launching the distortion reduction module 152. Additionally, the accelerometer 211 can be used to sense some of the gestures of the user, as well as a user walking slowing, presumably because the weather is good, or running, which can be interpreted to indicate that someone is trying to get out of the rain, walking fast, often due to uncomfortable weather (rain, wind, snow, hail), and so forth. Some of these weather conditions have associated therewith fog, haze, or reduced visibility that can lead to distortion in an image.

The accelerometer 211 can also be used to determine the spatial orientation of the electronic device 100 as well in three-dimensional space by detecting a gravitational direction. In addition to, or instead of, the accelerometer 211, an electronic compass can be included to detect the spatial orientation of the electronic device 100 relative to the earth's magnetic field. Similarly, one or more gyroscopes can be included to detect rotational motion of the electronic device 100. This spatial orientation can actually be used it infer weather conditions. For example, it can be due to a user's gestures, such as holding up an umbrella, turning up or down a user's collar, zipping up a jacket, putting hands in a pocket, and so forth, each which can then be interpreted to indicate a weather condition that includes fog or haze.

Other environmental sensors can optionally be included to infer, or detect directly, weather data. For example, a temperature monitor 212 can be configured to monitor the temperature of the environment. A moisture detector 213 can be configured to detect the amount of moisture on or about the display 102 or the housing 101 of the electronic device 100, which can indicate rain or drizzle responsible for distortion in images. The moisture detector 213 can be realized in the form of an impedance sensor that measures impedance between electrodes. As moisture can be due to external conditions, e.g., rain, or user conditions, perspiration, the moisture detector 213 can function in tandem with ISFETS configured to measure pH or amounts of NaOH in the moisture or a galvanic sensor 214 to determine not only the amount of moisture, but whether the moisture is due to external factors, perspiration, or combinations thereof.

The galvanic sensor 214 can also sense electrical charge in the air, which may indicate a thunderstorm, lightning, and other weather conditions that result in fog, haze, or reduced visibility leading to distortion in an image. A hygrometer 215 can be used to detect humidity, while a wind-speed monitor 216 can be used to detect wind. These environmental sensors are illustrative only, as numerous others will be obvious to those of ordinary skill in the art having the benefit of this disclosure.

Turning now back to FIG. 1, the electronic device 100 can include other components 110 as well. The other components 110 operable with the one or more processors 116 can include output components such as video, audio, and/or mechanical outputs. For example, the output components may include a video output component such as the display 102 or auxiliary devices including a cathode ray tube, liquid crystal display, plasma display, incandescent light, fluorescent light, front or rear projection display, and light emitting diode indicator. Other examples of output components include audio output components such as speaker port 132 or other alarms and/or buzzers and/or a mechanical output component such as vibrating or motion-based mechanisms.

It is to be understood that FIG. 1 is provided for illustrative purposes only and for illustrating components of one electronic device 100 in accordance with embodiments of the disclosure, and is not intended to be a complete schematic diagram of the various components required for an electronic device. Therefore, other electronic devices in accordance with embodiments of the disclosure may include various other components not shown in FIG. 1, or may include a combination of two or more components or a division of a particular component into two or more separate components, and still be within the scope of the present disclosure.

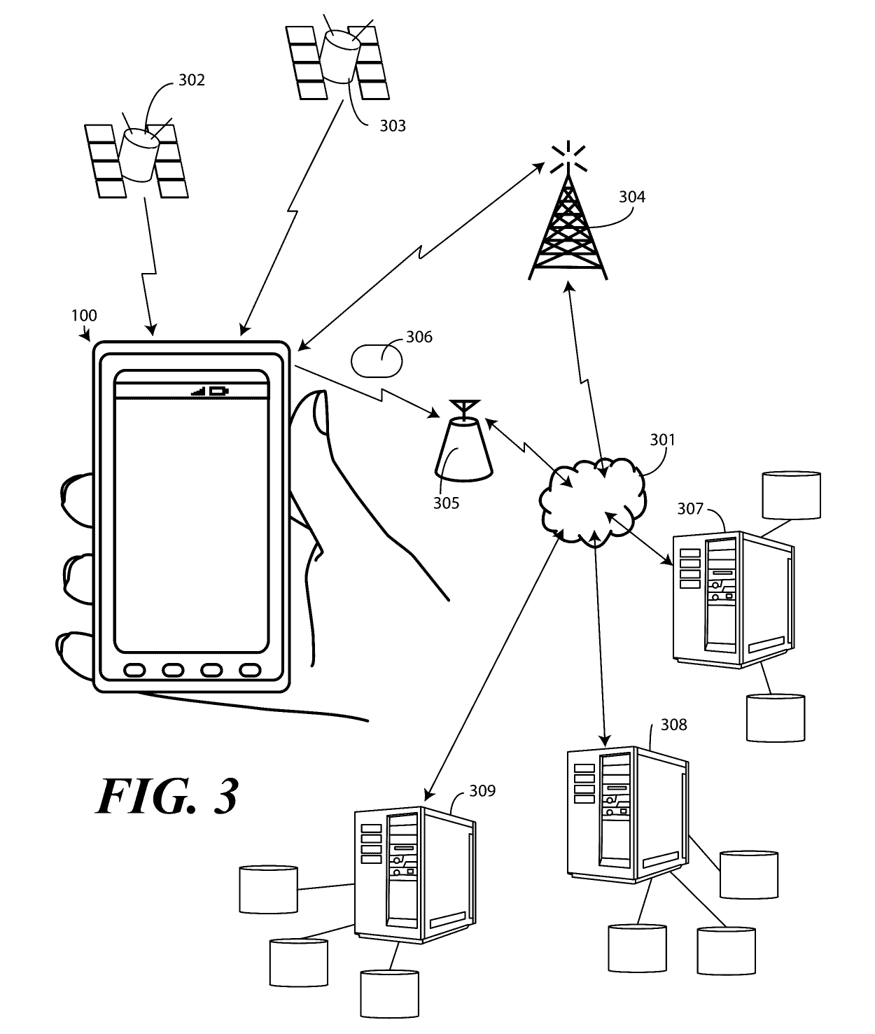

Turning now to FIG. 3, illustrated therein is the electronic device 100 communicating with various remote devices across a network 301. These other devices are illustrative, as others will be obvious to those of ordinary skill in the art having the benefit of this disclosure. Additionally, it should be noted that a particular electronic device 100 need not be able to communicate with each and every one of these devices. Some electronic devices will communicate with subsets of the devices, while others communicate with supersets of these devices.

In one embodiment, the electronic device 100 is able to determine location data when an image is captured from a constellation of one or more earth orbiting satellites 302,303, or from a network of terrestrial base stations 304 to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the electronic device 100 autonomously or with assistance from terrestrial base stations 304, for example those associated with a cellular communication network or other ground based network, or as part of a Differential Global Positioning System (DGPS), as is well known by those having ordinary skill in the art.

The electronic device 100 may also be able to communicate with terrestrial base stations 304 to a traditional cellular network, such as a CDMA network or GSM network. Other examples of networks with which the communication circuit may communicate include Push-to-Talk (PTT) networks, proprietary networks, dual band CDMA networks, or Dual Band Universal Mobile Telecommunications System (UMTS) networks, and direct communication networks.

The electronic device 100 may also be able to communicate with nodes 305 of Wi-Fi networks. One example of such a Wi-Fi network is the IEEE 801.11-based standard networks. Other local area networks include infrared networks, magnetic field modulation networks, and so forth.

In one or more embodiments, the electronic device 100 is able to communicate through one of these conduits across the network 301 to one or more servers. As noted above, in one or more embodiments the one or more processors (116) of the electronic device will obtain weather data of a location where the image was captured when distortion in an image is detected. In one embodiment, the step of obtaining weather data 306 can comprise retrieving the weather data 306 directly from one or more local environmental sensors of the electronic device 100 such as those illustrated above with reference to FIG. 2. While this can be the case, embodiments of the disclosure contemplate that not all electronic devices will include such sophisticated sensors. Where this is the case, the electronic device 100 may need to retrieve the weather data from an external source.

For example, in one embodiment the step of obtaining weather data 306 can include the one or more processors (116) retrieving, across the network 301 with the communication circuit (125), the weather data 306 from a weather service server 307. Where such a service is not available, the step of obtaining the weather data 306 can be more indirect. For example, in situations where no weather service is available, the one or more processors (116) may conduct a real time search, which may be a keyword search, image search, or other search, of social media services to find images or comments from a similar location. The one or more processors (116) may look for images posted on a social media service server that were taken at the same location to see if the same distortion exists. Alternatively, the one or more processors (116) may search for social media commentary regarding the location, such as, “Man, it sure was foggy today in Chicago,” which is in indication that weather-related conditions may be causing distortion in an image. Accordingly, in one or more embodiments, the step of obtaining weather data 306 can comprise retrieving, across the network 301 with the communication circuit (125), the weather data 306 or inferences of the weather data 306 by querying a social media server 308.

Other remote devices 309 can be queried as well. The other remote devices 309 can include other wireless communication devices. For example, one spouse may have a simple communication device without weather services, while another spouse may have a fancy communication device with weather services. The simple device may retrieve weather directly from the fancy device when the spouses are in a common location. In other embodiments, the other remote devices 309 can include servers hosting electronic messaging applications, such as instant messaging (IM) applications, text messaging applications, microblogging applications, and the like. Messaging applications can include a web-based email applications such as Google's Gmail™ or Microsoft Outlook™. Examples of messaging applications include, for example, text messaging applications such as simple messaging service (SMS) applications or multimedia messaging service (MMS) applications. Examples of microblogging applications include Twitter™. These are illustrative only, as other services and devices from which weather-related data can be retrieved will be obvious to those of ordinary skill in the art having the benefit of this disclosure.

In one or more embodiments, regardless of whether from remote devices 309 or from local sensors, the one or more processors (116) receive the weather data 306 to determine weather conditions that could be the source of distortion occurring in images. In one embodiment, the one or more processors (116) determine these conditions as a function of the weather data 306 and location data in which the electronic device 100 is located when the image is captured. The weather data 306 can explicitly indicate weather conditions, such as the barometer (201) sensing a pressure change, the temperature monitor (212) sensing the temperature, the hygrometer (215) sensing humidity, or the light sensor (206) camera sensing light intensity. The weather data 306 can also be retrieved from the weather service server 307 to explicitly determine these weather conditions. As noted above, the weather data 306 can also be implicitly interpreted from queries, be they text, image, or other, of social media servers 308. Such queries result in weather data 306 is interpretable but may not explicitly indicate a weather condition. However, the inferences may be sufficient for the one or more processors (116) to conclude that weather conditions are causing distortion in a captured image. Some of this weather data may seem to explicitly indicate weather conditions, but in practical terms must first be interpreted by the one or more processors (116).

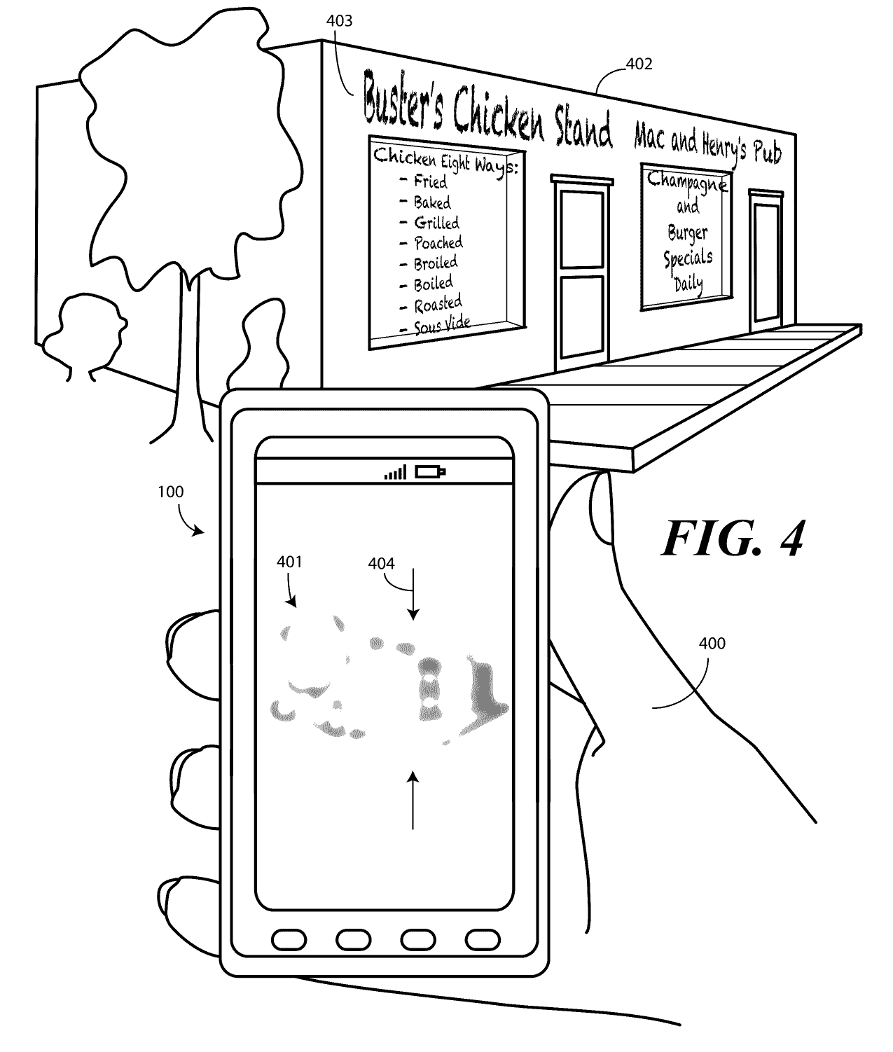

Turning now to FIG. 4, illustrated therein is a user 400 taking an image 401 of a building 402 using the camera (140) of the electronic device 100. As shown, the image 401 includes distortion 404. While general distortion can include different elements, including blur, haze, and an out-of-focus condition, here the image 401 suffers from all three. The building 402 is blurred, the signage 403 “Buster's Chicken Stand” is illegible, and the image 401 suffers from general haze.

In one embodiment, the one or more processors (116) of the electronic device 100 detect this distortion 404 using the distortion detection module (151) as previously described. The problem is that this distortion 404 can be caused by different sources. Weather conditions, such as fog, wind, or rain, can cause the distortion 404 occurring in the image 401. At the same time, smudges, dirt, or foreign matter on exterior portions of the image capture device can cause the distortion as well. Advantageously, embodiments of the disclosure help to distinguish between weather-related distortion and non-weather-related distortion to help the user 400 obtain a sharper, clearer, and more pleasing image.

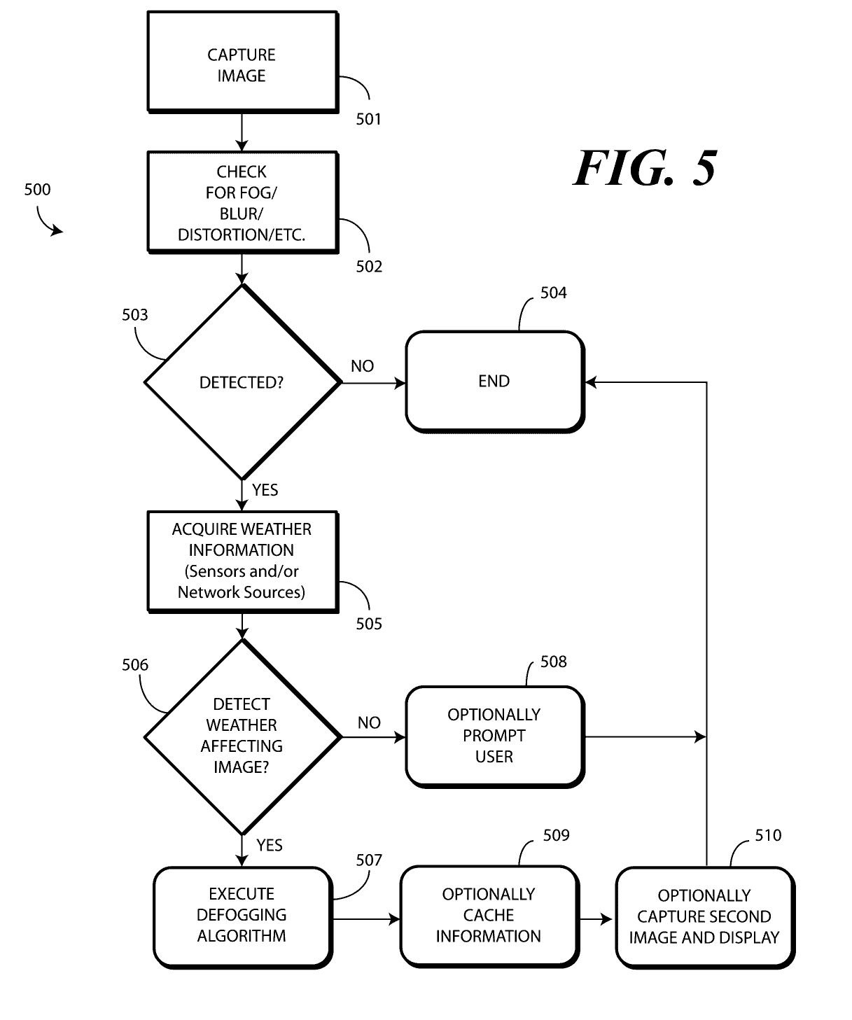

Turning now to FIG. 5, illustrated therein is one explanatory method 500 for doing this. Beginning at step 501, the method 500 includes capturing an image with an imager or image capture device of an electronic device. This step 501 was shown occurring in FIG. 4. In one or more embodiments, this step 501 further comprises determining, with the one or more processors, the location where the image was taken. In one embodiment, this includes determining the location with one or more location devices. For example, the one or more processors can detect the location where the image was captured using the location detector, e.g., global positioning system device (209) of FIG. 2 or other terrestrial equivalent.

At step 502, the method 500 includes detecting, by one or more processors of the electronic device, distortion in the image captured by the imager or image capture device of the electronic device. One example of such distortion was shown in FIG. 4 as distortion (404). Numerous methods of detecting this distortion have been described above. Any of these can be used, alone or in combination to detect the distortion.

At decision 503, the method 500 determines whether distortion was detected. Where there is no distortion, the method 500 can simply end at step 504 because no image correction is necessary. However, where distortion is detected at decision 503, the method 500 must determine if the distortion was weather-related.

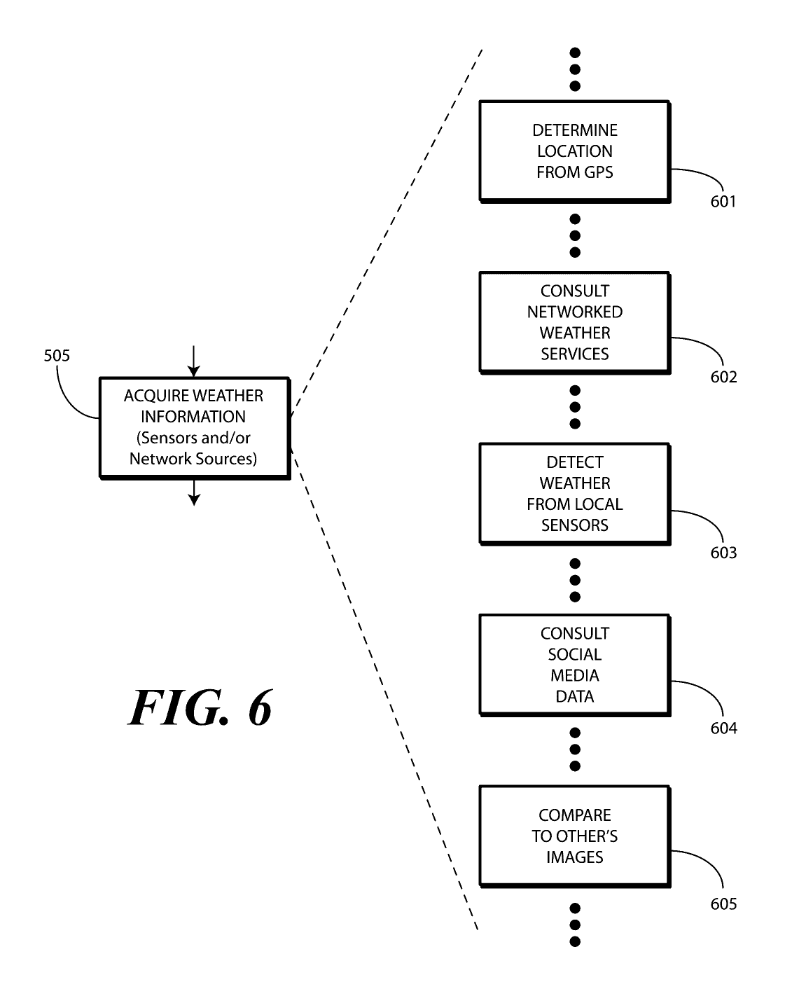

Proceeding to step 505, the method 500 next obtains, with one or more processors of the electronic device, weather data of a location where the image was captured. As noted above, this step 505 can occur in a variety of ways. Many of these ways are shown in FIG. 6.

Turning briefly to FIG. 6, shown therein are several different options for executing step 505. If location was not determined at step (501), location can be determined at step 505 as shown at step 601 of FIG. 6. Once location is determined, weather data can be pulled at step 505.

In one embodiment this step 505 comprises, at step 602, retrieving, across a network with a communication circuit operable with the one or more processors, the weather data from a weather service server. In another embodiment, this step 505 comprises, at step 604, retrieving, across a network with a communication circuit operable with the one or more processors, the weather data by querying a social media server, as previously described. In one embodiment, step 505 can comprise retrieving other's images from the Internet or from social media servers for comparison. If, for example, someone took a picture at about the same location, and at about the same time as when the image was captured, and this image is blurry as well, it is likely that the distortion was caused by weather.

In yet another embodiment, this step 505 comprises, at step 603 retrieving the weather data from one or more local environmental sensors of the electronic device operable with the one or more processors. Other techniques for obtaining weather data will be obvious to those of ordinary skill in the art having the benefit of this disclosure. Regardless of which technique is used, in one embodiment the one or more processors can then retrieve weather data for that location, at the time the image was taken, at step 505.

Turning now back to FIG. 5, the method 500 then determines, at decision 506, whether the weather data obtained at step 505 indicates one or more weather conditions causing the distortion. At step 507, where the one or more weather conditions cause the distortion, the method 500 can perform, with the one or more processors of the electronic device, distortion reduction on the image to reduce weather-related distortion occurring in the image. In one or more embodiments, step 507 can further include presenting a prompt on a user interface that includes an indication that the distortion reduction process was performed. For instance, once the distortion reduction was completed, the one or more processors might place the original image next to the distortion-reduced image along with a prompt that states, “Distortion reduction was performed on the image on the right—do you like it better?” This would allow a user to select which image they preferred—the uncorrected one or the corrected one.

Illustrating by example, if the image was taken in Piedmont Park, located in Atlanta, Ga., and the weather data indicates that the weather conditions were foggy in the park when the image was taken, decision 506 determines that this fog may be the source of the distortion because fog can cause objects in images to distort with one or more of blur, haze, an out of focus condition, combinations thereof, or other factors. Accordingly, the method 500 proceeds to step 507 to perform distortion reduction on the image to reduce the weather-related distortion occurring in the image. Numerous methods of performing such distortion reduction have been described above. Any of these can be used, alone or in combination to reduce weather-related distortion occurring in the image. One illustrative example of a distortion reduction technique suitable for this situation is applying a defogging image correction process, as described above, to the image.

On the other hand, i.e., where the weather data indicates that distortion is caused by conditions other than the one or more weather conditions, the method 500 proceeds to step 508. Since weather is not the cause, other factors such as smudging, dirt, debris, or other materials on at least a portion of an external component of the imager or image capture device, such as the lens, may be causing the distortion. Accordingly, at step 508 the method 500 can, with the one or more processors, present a prompt on the user interface. Illustrating by example, the one or more processors might present a message with the captured image saying, “This image appears blurry. You may want to check the lens to make sure it's clean.” In other embodiments, the prompt can include a notification to clean at least a portion of the image capture device. For instance, the prompt might say, “Blurry picture detected—please clean lens.” Other indicia suitable for inclusion into the message will be obvious to those of ordinary skill in the art having the benefit of this disclosure.

In one or more embodiments, optional step 509 can be included. At step 509, the method 500 can include caching identification data indicating the distortion in the image occurred. This identification information, which can include such items as location, amount of distortion, time of day, weather conditions, and so forth. This information can be used, for example, by a manufacturer when determining whether the electronic device is covered by warranty. The information can also be used in troubleshooting problems with the electronic device.

In one or more embodiments, the method 500 can optionally include the step 510 of capturing a second image. In some cases a user may not want their original photograph altered in any way, but may desire to see a distortion-reduced image as well. In such a situation, the method 500 can optionally capture a second image, perform distortion reduction on it, and then present it alongside the original so that the user can select which image they prefer.

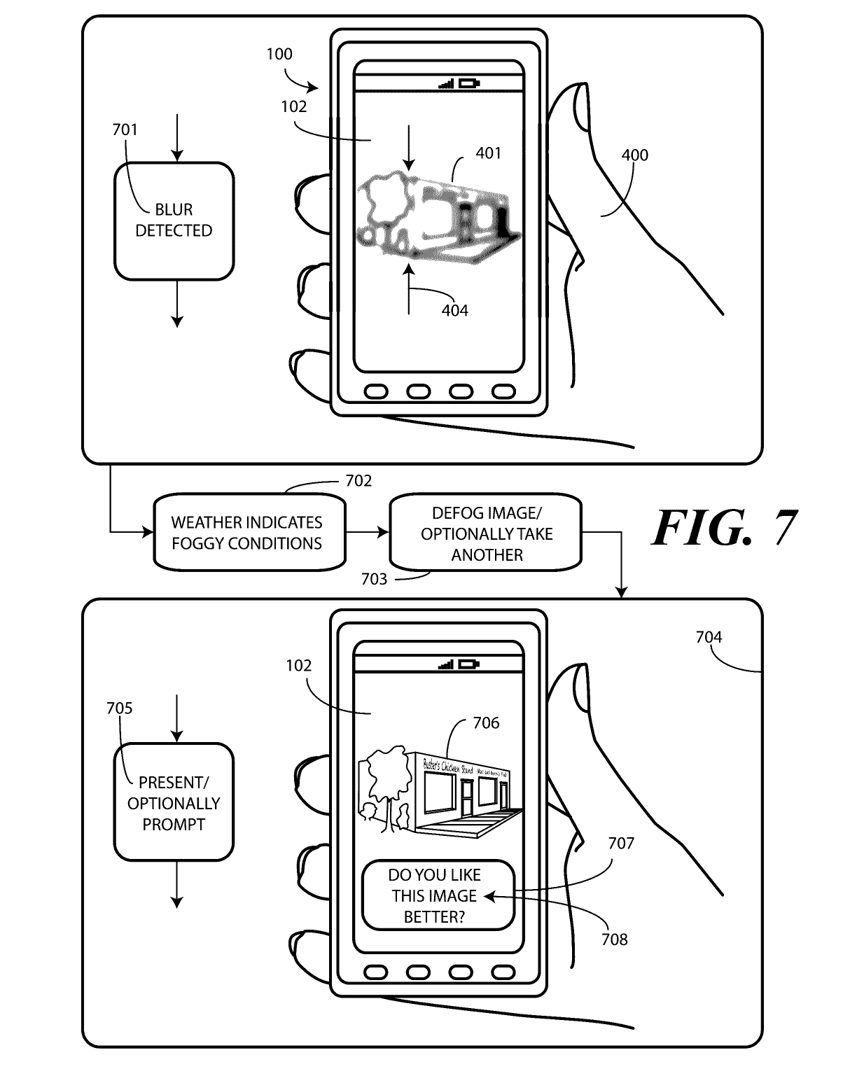

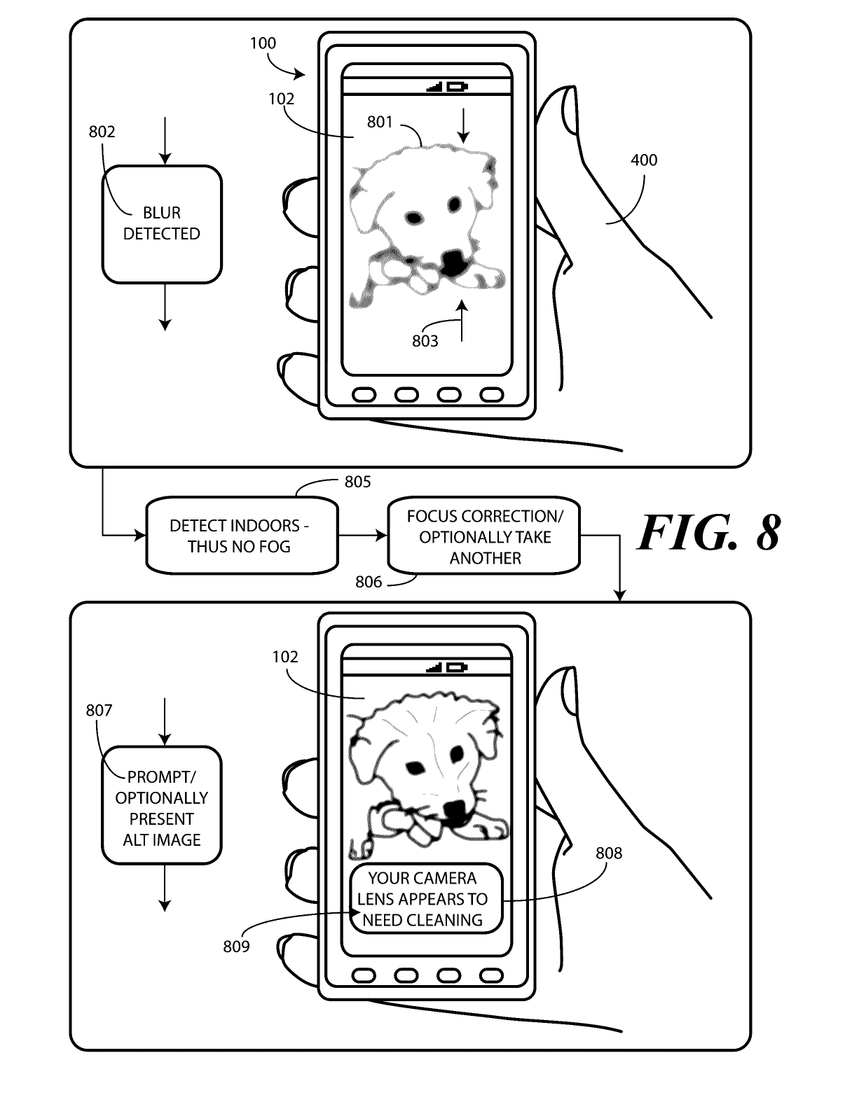

Turning now to FIGS. 7 and 8, illustrated therein are a couple of use cases that illustrate devices and methods configured in accordance with one or more embodiments of the disclosure in action. Beginning with FIG. 7, the user 400 is shown as in FIG. 4 holding the electronic device 100 with the image 401 taken in FIG. 4 presented on the display 102. Recall from above that the electronic device 100, in one embodiment, includes an image capture device, such as a camera (140), a user interface (111) that includes the display 102, and one or more processors (116) that are operable with the image capture device and the user interface (111). Here, the one or more processors (116) have received the image 401 from the image capture device, and have detected 701 that distortion 404 is occurring in the image 401.

Accordingly, as described above with reference to FIGS. 5 and 6, the one or more processors (116) obtain weather data of the location where the image was captured. At step 702, the one or more processors (116) determine that the weather data indicates that a weather condition—in this case fog—was responsible for the distortion 404. At step 703, the one or more processors (116) perform distortion reduction on the image 401 to reduce weather-related distortion occurring gin the image 401. At step 704, the one or more processors (116) present 705 the distortion-reduced image 706 on the display 102 of the electronic device 100. In one or more embodiments, the one or more processors (116) also present a prompt 707 comprising an indication 708 that the distortion reduction process was performed. This illustrative indication 708 states, “Do you like this image better?”, thereby indicating that the original image 401 has been changed.

In FIG. 8, a different process occurs. As with FIG. 7, the user 400 is shown holding the electronic device 100 with an image 804 presented on the display 102. In this case, the user has taken a picture of their dog, Buster. As was the case with the image (401) of FIGS. 4 and 7, the one or more processors (116) have received the image 801 from the image capture device, and have detected 802 that distortion 803 is occurring in the image 801.

In contrast to the use case shown in FIG. 7, in FIG. 8 the one or more processors (116) determine that the electronic device 100 is indoors at step 805. Accordingly, any weather data retrieved would be confined to indoor spaces at this location. As such, the weather data would not indicate weather conditions that could be causing the distortion 803. The more likely cause of the distortion 803 is smudging, dirt, or debris on the lens of the camera (140).

In one embodiment where this is the case, the one or more processors (116) can optionally perform distortion reduction on the image 801 at step 806. It should be noted that defogging techniques and other techniques can be used not only to reduce weather related distortion, but other distortion as well. Thus, in one embodiment the one or more processors (116) can perform distortion reduction regardless of the cause of the distortion 803.

However, independent of whether distortion reduction is performed, in one embodiment when the one or more processors (116) determine that weather data does not indicate that the distortion 803 was caused by weather, the one or more processors can present 807 a prompt 808 on the display 102. In one embodiment, the prompt 808 can comprise a notification 809 to clean at least a portion of the image capture device, which is the camera (140) in this illustrative embodiment.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method in an electronic device, comprising:
detecting, by one or more processors, distortion in an image captured by an imager of the electronic device;
obtaining, by the one or more processors, weather data of a location where the image was captured;
determining, by the one or more processors, whether the weather data indicates one or more weather conditions causing the distortion; and
where the one or more weather conditions cause the distortion, performing, with the one or more processors, distortion reduction on the image to reduce weather-related distortion occurring in the image.

2. The method of claim 1, the distortion comprising one of blur, haze, an out of focus condition, or combinations thereof.

3. The method of claim 1, the one or more weather conditions comprising fog.

4. The method of claim 1, the distortion reduction comprising applying a defogging image correction process to the image.

5. The method of claim 1, further comprising, where the weather data indicates that distortion is caused by conditions other than the one or more weather conditions, presenting, by the one or more processors, a prompt on a user interface.

6. The method of claim 5, the prompt comprising a notification to clean at least a portion of the imager.

7. The method of claim 1, further comprising capturing a second image.

8. The method of claim 1, further comprising presenting, with the one or more processors, a prompt on a user interface comprising an indication that the distortion reduction was performed.

9. The method of claim 1, further comprising determining, by the one or more processors, the location with one or more location detection devices.

10. The method of claim 9, the obtaining comprising retrieving, across a network with a communication circuit operable with the one or more processors, the weather data from a weather service server.

11. The method of claim 9, the obtaining comprising retrieving, across a network with a communication circuit operable with the one or more processors, the weather data by querying a social media server.

12. The method of claim 1, the obtaining comprising retrieving the weather data from one or more local environmental sensors of the electronic device operable with the one or more processors.

13. The method of claim 1, further comprising caching identification data indicating that the distortion in the image occurred.

14. An electronic device, comprising:
an image capture device;
a user interface; and
one or more processors, operable with the image capture device and the user interface;
the one or more processors to:
receive an image from the image capture device;
detect distortion is occurring in the image;
obtain weather data of a location where the image was captured;
determine whether the weather data indicates a weather condition responsible for the distortion; and
where the weather data indicates a weather condition responsible for the distortion, perform distortion reduction on the image to reduce weather-related distortion occurring in the image.

15. The electronic device of claim 14, further comprising one or more environmental sensors, disposed in the locally in the electronic device, the one or more processors to obtain the weather data from the one or more environmental sensors.

16. The electronic device of claim 14, further comprising a location detector, the one or more processors to determine the location with the location detector while the image is being captured.

17. The electronic device of claim 14, further comprising a communication circuit, the one or more processors to obtain the weather data by communicating, with the communication circuit, with a remote server across a network.

18. The electronic device of claim 17, the remote server comprising a weather service server.

19. The electronic device of claim 17, the remote server comprising a social media server.

20. The electronic device of claim 14, further comprising the user interface, the one or more processors further to, where the distortion is caused by a condition other than the weather condition, present a prompt on the user interface comprising a notification to clean at least a portion of the image capture device.
